(19) United States
(12) Patent Application Publication
(10) Pub. No.: US 2006/0289468 A1
(43) Pub. Date: Dec. 28, 2006

(54) Snow and ice melting mat

(76) Inventors: Randy Seibert, Northglenn, CO (US); John J. Alcamo, Arvada, CO (US)

Correspondence Address: NORRIS MCLAUGHLIN & MARCUS, P.A., P O BOX 1018, SOMERVILLE, NJ, 08876, US

(21) Appl. No.: 11/377,776

(22) Filed: Mar. 16, 2006

Related U.S. Application Data
(60) Provisional application No. 60/662,640, filed on Mar. 17, 2005.

(51) Int. Cl. H05B 3/34; H05B 3/54

(52) U.S. Cl. 219/528

(57) ABSTRACT

A flexible electric heating mat includes a grounding substrate sheet arranged in relation to electrical conductors and resistive elements of an electric heater element so as to provide safe and reliable operation of the mat in environments in which the mat will be subjected to moisture and physical stresses.

### CROSS REFERENCE TO RELATED APPLICATION

This application claims the benefit of U.S. Provisional Application No. 60/662,640 filed Mar. 17, 2005, and incorporated by reference herein.

### FIELD OF THE INVENTION

The present invention relates generally to flexible electric heating mats and, more particularly, to a flexible electric heating mat for melting snow or ice accumulating thereon that can be safely used in an environment where the mat will experience physical stresses and be exposed to moisture.

### BACKGROUND OF THE INVENTION

An electric heating mat or pad for melting snow or ice is desirable for installation on, for example, sidewalks, driveways or other walkways of commercial or residential properties located in geographic regions that experience severe winter weather conditions. The installation of the electric heating pad on surfaces upon which snow or ice is likely to accumulate avoids the need to expend substantial time and effort, and sometimes substantial financial resources, to shovel snow and remove ice from such surfaces.

There are various ice and snow melting electric heating mats discussed in the prior art. For example, U.S. Pat. No. 4,656,339, incorporated by reference herein, describes a heating tape including resistive elements coupled to electrical conductors, where the resistive elements and conductors are hermetically sealed between outer plastic covering sheets. The heating tape of the '339 patent, however, does not include a grounding means that can protect an individual from coming into contact with live (energized) electrical conductors or resistive elements within the heating tape, which can become exposed to the environment if the tape is punctured or the plastic covering sheet wears away. Thus, such heating tape cannot be safely operated in an environment where the tape likely will experience physical wear or be punctured and, therefore, has a limited number of safe uses.

U.S. Pat. Nos. 6,180,929 and 6,184,496, incorporated by reference herein, describe electric heating pads which, according to the patents, a consumer can readily cut to a desired size, lengthwise or across its width, without expending significant effort, without using specialized tools or equipment and without having knowledge of technical matters. Similar to the heating tape of the '339 patent, the heating pad described in the '929 patent and several of the embodiments of the heating pad described in the '494 patent do not include a grounding means, such that the same safety issues as described above for the tape of the '339 patent are present in these heating pads. Although the '496 patent describes that the heating pad can include a grounding substrate, it has been found that the pad of the '496 patent including the grounding substrate usually fails to operate upon or soon after installation. Furthermore, it has been found that if the pad of the '496 patent including the ground substrate is cut in the field lengthwise and then resealed at the cut portions using conventionally available electrical sealants or adhesives, as described in the '496 patent, the pad usually fails to operate when electrical power is re-applied to the pad.

Despite the description of various electric heating mats in the prior art, there is still a need for an electric heating mat that provides reliable and safe operation when installed in an environment where the mat will be exposed to moisture and also physical stresses, such as wear and puncture.

### SUMMARY OF THE INVENTION

In accordance with the present invention, an electric heating mat includes resistive elements coupled to electrical conductors and also a grounding substrate sheet disposed at least a predetermined distance away from any portion of an electrically conductive component of the mat which is not covered by non-conductive material. The predetermined distance is a minimum separation distance that must be maintained between the grounding substrate sheet and any portion of an electrically conductive component not covered by non-conductive material to prevent arcing of electrical energy between the grounding substrate sheet and any portion of an electrically conductive component not covered by non-conductive material when the electrically conductive components are energized by electrical current provided by an electrical power source.

In a preferred embodiment of the present invention, an electric heating mat includes an electric heater element with a non-conductive sheet containing resistive elements coupled to electrical conductors, where the resistive elements and the conductors extend between top and bottom surfaces of the non-conductive sheet. The electrical conductors preferably extend longitudinally along the length of the sheet at opposing lateral edges of the sheet, and the resistive elements, which are preferably parallel to one another, extend between and are electrically coupled at their ends to the electrical conductors. A grounding substrate sheet is coupled to the top surface of the heater element. All portions of the perimeter edge of the grounding substrate sheet are disposed at least a predetermined distance away from any portion of an electrical conductor or a resistive element of the heater element not covered by the material of the non-conductive sheet. The predetermined distance is a minimum separation distance that must be maintained between the grounding substrate sheet and any portion of the electrical conductors or the resistive elements not covered by material of the non-conductive sheet to prevent arcing of electrical energy between the grounding substrate sheet and any portion of the conductors or a resistive element not covered by material of the non-conductive sheet when the electrical conductors of the mat, and consequently the resistive elements, are energized by electrical current provided by an electrical power source. The mat further includes top and bottom protective coverings adhesively bonded to the grounding substrate sheet and the bottom surface of the heater element, respectively, and to each other at their respective opposing edges. In addition, the mat includes head end and tail end terminations adhesively bonded to respective head and tail edges of the top and bottom protective coverings. The adhesive bonds formed between the top and bottom protective coverings, and between the top and bottom coverings and each of the head and tail end terminations, establish a hermetic seal about the heater element and the grounding substrate sheet.

### BRIEF DESCRIPTION OF THE DRAWINGS

Other objects and advantages of the present invention will be apparent from the following detailed description of the presently preferred embodiments, which description should be considered in conjunction with the accompanying drawings in which like references indicate similar elements and in which:

FIG. 1 is a perspective view of an electric heating mat in accordance with the present invention.

FIG. 2 a cross-sectional view of the mat of FIG. 1 taken along lines 2-2.

FIG. 3 a cross-sectional view of the mat of FIG. 1 taken along lines 3-3.

FIG. 4 is a top view of the heater element of the mat of FIG. 1.

FIG. 5 is an enlarged, top view of a portion of the head end edge of the heater element of the mat of FIG. 1.

FIG. 6 is a bottom view of the heater element of the mat of FIG. 1.

### DETAILED DESCRIPTION OF THE INVENTION

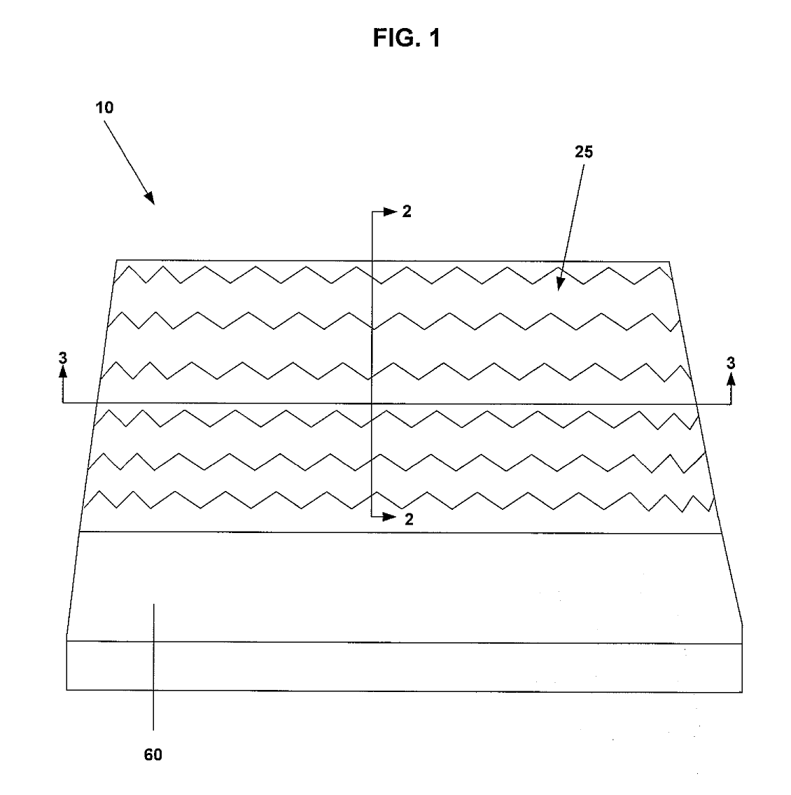

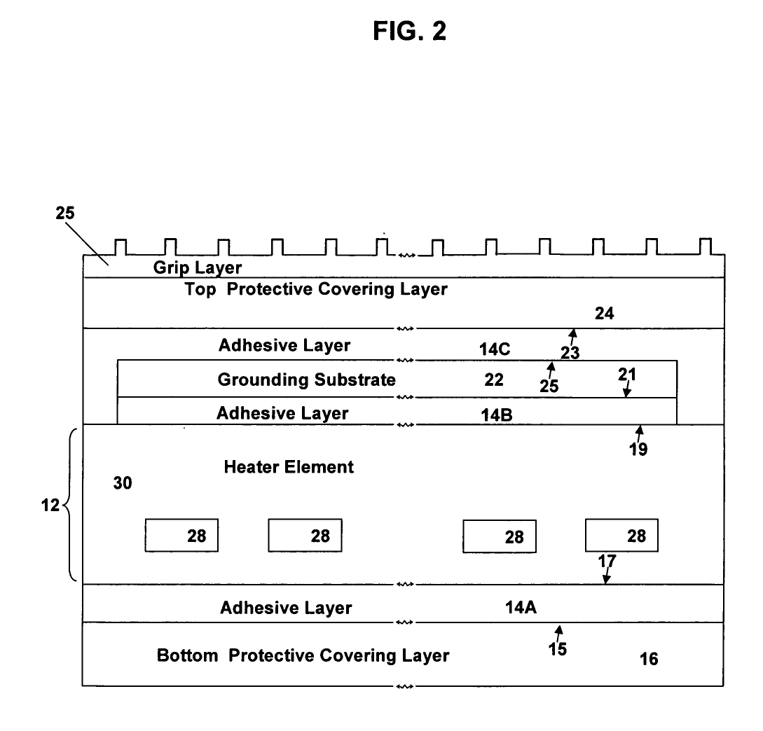

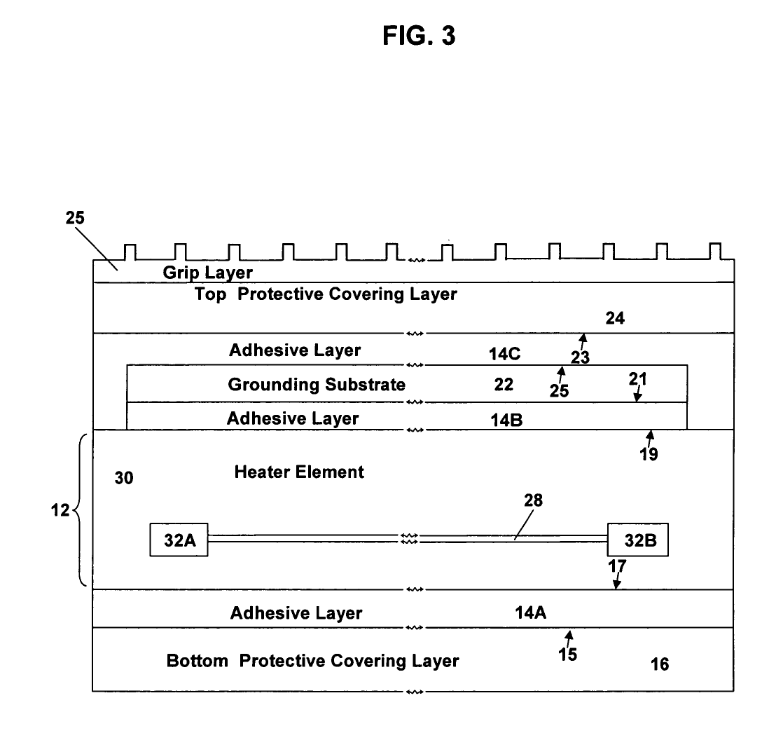

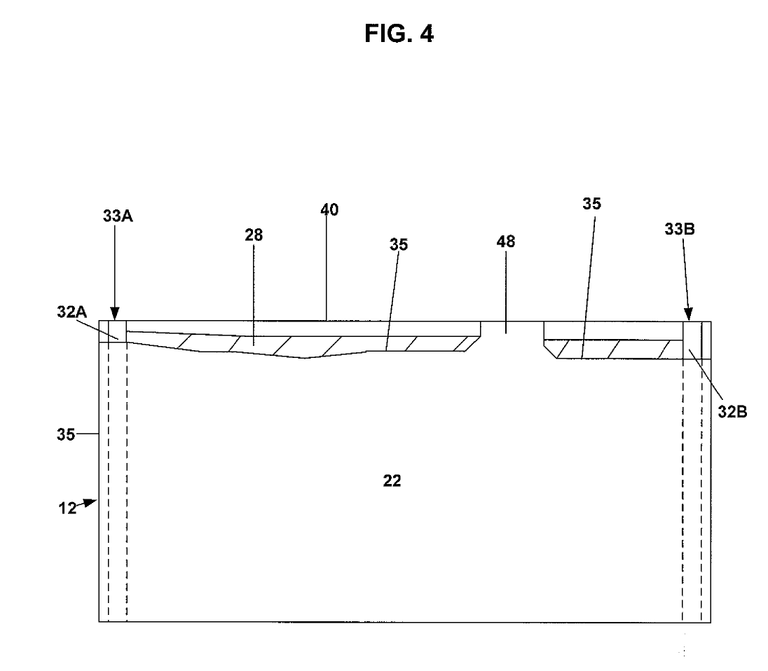

Referring to FIG. 1, which is a perspective view of a preferred embodiment of an electric heating mat 10 in accordance with the present invention, and also to FIGS. 2 and 3, which are cross-sectional views of the mat 10 of FIG. 1, and FIG. 4, which is top view of an electric heater element 12 contained with the mat 10, the mat 10 is an elongated, flexible pad containing the heater element 12, which preferably extends substantially the entire longitudinal and latitudinal lengths of the mat 10. The mat 10 is intended for installation, and safe and reliable operation, on a surface requiring snow and ice removal where it is expected that the surface, and thus, the mat 10 will likely experience severe physical stresses, such as from high levels of friction associated with vehicular or foot traffic, or from puncture by a blunt or sharp object.

Still referring to FIGS. 1-4, the mat 10 includes an adhesive layer 14A bonded to an upper surface 15 of a bottom, water impermeable, protective rubber covering layer 16 and also to a lower surface 17 of the heater element 12. In addition, an adhesive layer 14B bonds substantially all of an upper surface 19 of the heater element 12 to a lower surface 21 of a metallic grounding substrate sheet 22. Further, an adhesive layer 14C bonds a lower surface 23 of a top, water impermeable, protective rubber covering layer 24 to an upper surface 25 of the grounding substrate sheet 22, and also to portions of the upper surface 19 of the heater element 12 that the grounding substrate sheet 22 does not overlie. The top and bottom covering layers 24 and 16 extend co-extensively with the surfaces 17 and 19, respectively, of the heater element 12. In addition, a grip layer 25 is preferably coupled to and extends co-extensively with the top covering layer 24.

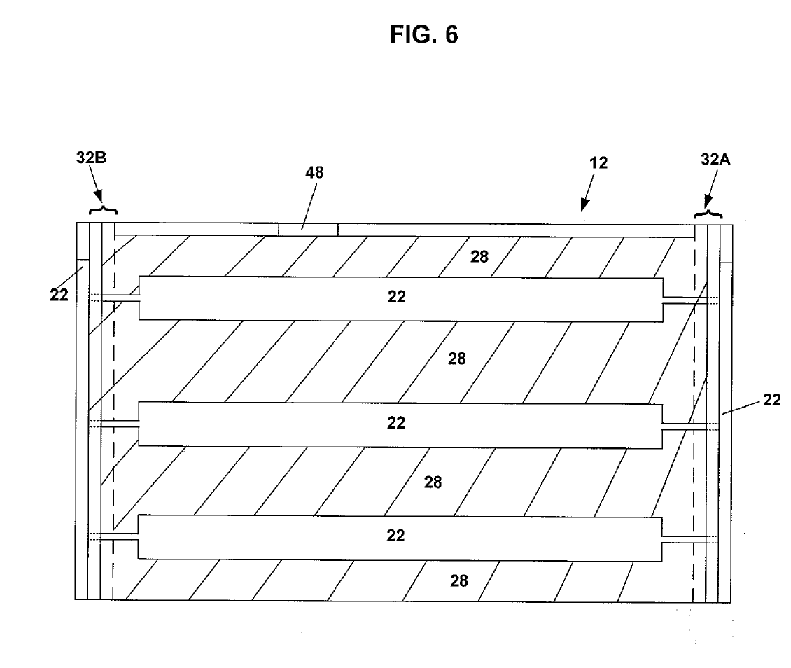

Referring to FIGS. 1-4 and also to FIG. 6, which is a bottom plan view of the mat 10, the heater element 12 is in the form of a flexible sheet of non-conductive material 30, such as plastic. The upper and lower surfaces 19, 17 of the heater element 12 correspond to the upper and lower surfaces, respectively, of the non-conductive sheet 30. The non-conductive sheet 30 contains a plurality of resistive elements 28 in the form traces that are spaced from one another, disposed between the upper and lower surfaces 19, 17 and extend in the transverse direction across the mat 10 between the lateral edges of the mat 10. The traces 28 are preferably parallel to one another. The non-conductive sheet 30 also contains electrical conductors 32A, 32B that are disposed between the upper and lower surfaces 19, 17 and extend longitudinally along the length, and are adjacent to the opposing lateral edges, of the mat 10, and preferably extend perpendicular to the resistive traces 28. The resistive traces 28 are electrically coupled at their opposing ends to the electrical conductors 32A and 32B, respectively.

The resistive traces 28 are made from resistive materials conventionally used in an electric heating mat, and the conductors 32A, 32B include electrically conductive materials conventionally used in conductive elements that are for conveying electrical energy, such as 120 VAC of electrical current.

The grounding substrate sheet 22 includes aluminum or an alloy thereof as conventionally known in the art.

The covering layers 16 and 24 are made of thin, flexible insulating polymeric material conventionally known in the art. The grip layer 25 is preferably made of molded rubber.

In a preferred embodiment, the grounding substrate sheet 22 has a thickness of about 3 mils, the thickness of the adhesive layer 14B between the grounding substrate 22 and the heater element 12 is about 2 mils, and the thickness of the heater element 12 is about 14 mils.

In a preferred embodiment, during manufacture of the mat 10, the heater element 12 with the grounding substrate sheet 22 already adhesively bonded thereto is attached to the bottom and top protective layers 16 and 24 by application of adhesive material that forms the layers 14A, 14B and 14C. In a further preferred embodiment, the adhesive layer 14B and 14C constitute an integral layer.

In operation of the mat 10, the resistive traces 28 in the electric heater element 12, based on the conduction of electrical current supplied from the conductors 33, generate heat to melt snow and ice that accumulates on the top covering layer 24 or the grip layer 25.

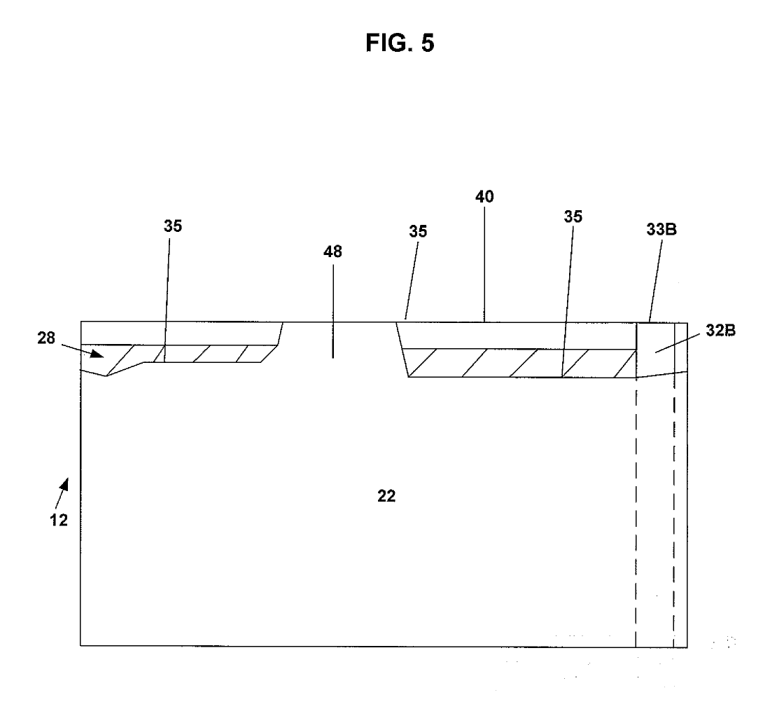

Referring to FIGS. 4 and 5, in accordance with the present invention, all portions of a perimeter edge 35 of the grounding substrate sheet 22 of the mat 10 are located at least a predetermined distance away from any portion of a component of the mat 10 which is electrically conductive and is not covered by non-conductive material. For the mat 10, the predetermined distance, or predetermined spacing criteria, is a minimum separation distance that must be maintained between the grounding substrate sheet 22 and any portion of the electrical conductors 32 or the resistive traces 28 not covered by material of the non-conductive sheet so as to prevent arcing of electrical energy between the grounding substrate sheet 22 and any portion of the conductors 22 or the traces 28 not covered by material of the non-conductive sheet 22 when the electrical conductors 32 of the mat 10 are energized by electrical current provided by an electrical power source.

The predetermined distance is determined as a function of the material characteristics, physical dimensions and arrangement of the components within the heater element 12, namely, the material contained in the non-conductive sheet 30, the resistive traces 28 and the conductors 32, and also the electrical energy expected to be supplied to the conductors 32 from an energy source.

Referring to FIGS. 4-5, preferably during manufacture of the mat 10, a portion of the grounding substrate sheet 22 is stripped back and removed in relation to exposed end edge portions 33A, 33B of the conductors 32A, 32B, respectively, to avoid arcing of electric current between the exposed end edge portions 33A, 33B and the edge portion 35 of the grounding substrate sheet 22 nearest to the exposed edge portions 33A, 33B. If arcing were to occur between the grounding substrate sheet 22 and any of the conductors 32A or 32B, a short circuit would be created and damage the electric heater element 12, most likely causing it to become permanently inoperable.

Thus, the mat 10 having the grounding substrate sheet 22 as required in accordance with the present invention could not be modified and still maintain its reliability and safety if the predetermined spacing criteria was not satisfied. For example, if the mat 10 were cut in the lateral dimension across either a resistive trace 28 or a space between adjacent resistive traces 28, and then resealed using conventional adhesives without maintaining a sufficient distance between the grounding substrate sheet 22 and an end edge portion of a resistive trace 28 or an edge portion 33 of a conductor 32 not covered by the non-conductive material of the non-conductive sheet 30, the grounding substrate sheet 22 would be a part of a path of least resistance for electric current and result in a short circuit (electrical arcing) between the grounding substrate sheet 22 and the trace 28 or the conductor 32 when the mat 10 is re-energized, thereby causing the mat 10 to permanently fail.

Referring to FIGS. 4-6, the grounding substrate sheet 22 extends longitudinally from adjacent a tail end (not shown) of the mat 10, across substantially the entire lateral dimension of the mat 10, to a region co-extensive with the resistive trace 18 located nearest to the head end edge 40 of the heater element 12 (“head end resistive trace”). The portion of the edge 35 of the grounding substrate sheet 22 at the head end of the mat 10 is preferably at least two inches from the head end edge 40 of the heater element 12, and thus at least two inches from the exposed edges portion 33A and 33B.

In a preferred embodiment, the grounding substrate sheet 22 at the head end of the mat 10 does not extend to the respective head end edge 40 of the underlying heater element 12, except for a narrow strip of a ground shield extension 48 that extends away from the grounding substrate sheet 22 and to the head end edge 40. The narrow strip of the ground shield extension 48 is preferably about one inch in lateral width and two inches in longitudinal length, and extends to a point adjacent to the head end edge 40 of the heater element 12. The head end edge of the grounding substrate sheet 22, except for the extension 48, extends substantially across the mat 10 co-extensive with the head end resistive trace 28.

It is to be understood that the tail end of the mat 10 includes a ground shield extension (not shown) having a construction and configuration in relation to uncovered end edge portions of the conductors 32 that is similar to that described above for the head end of the mat 10.

Referring again to FIG. 1, the mat 10 preferably includes a head end termination 60 formed from conventional non-conductive materials, such as rubber. The termination 60 encapsulates electric wiring and associated electrical connections that are coupled to the conductors 32A and 32B and the grounding substrate sheet 22 and function to convey electrical current to the heater element 12 from a power source. The electrical current is supplied, for example, from a conventional AC voltage source. The electrical connections preferably include a hot electric wire connection to one of the conductors 32, a neutral electric wire connection to the other conductor 32 and a ground wire connection to the ground shield extension 48.

In preferred embodiments, the mat 10 can be manufactured to a specified longitudinal length, and also to specified widths, such as one or two foot wide widths that include two conductors 32, as described above and shown in FIG. 1, or a three foot wide or wider widths including three or more conductors 32. The mat 10 with three or more conductors is identical in construction and operation to the two conductor mat, except that an additional conductor extends longitudinally along the length of the mat intermediate the two edge conductors. For example, in the three conductor embodiment, the two conductors at the lateral edges are connected as the hot electric contacts and the intermediate conductor is the neutral connection. The additional conductor is added to ensure that sufficient current reaches the portions of the traces located furthest away from the conductors, such that sufficient heating is generated across the entire lateral width of the mat.

The components of the heater element 12 are adhesively coupled to one another, and the top and bottom covering layers are adhesively coupled to the heater element 12, using a very high strength adhesive that usually is applied only in a factory setting. The adhesive bond between the heater element 12 and the covering layers is of such high strength that it is almost impossible, if not impossible, to separate either of the covering layers from the heater element 12 manually or by using cutting tools without severely damaging or destroying the individual components of the heater element 12 or the grounding substrate sheet 22. Therefore, once the mat 10 has been completely manufactured, a consumer who has purchased the mat cannot obtain access to the heater element 12 or the grounding substrate sheet 22 that are internal to the mat 10, such as by removing one or both of the protective covering layers, without damaging or destroying the heater element 12 to render the mat permanently inoperable.

Thus, the inventive mat 10 is for manufacture based on a predetermined specifications concerning length and width. A consumer cannot readily cut the mat following purchase, such as in a home or office building environment, to reduce its lengthwise dimension and then perform the necessary modifications on the mat, i.e., re-establish the required separation distance between the grounding substrate sheet and an exposed conductor or resistive trace to avoid arcing to the grounding substrate sheet and then reseal the cut edge portion to make it watertight, to maintain continued reliable and safe operation of the mat. Further, a portion of the mat cannot be removed from either lateral edge because this would disrupt the distribution of electrical power to the traces 28 on the portion of the mat 10 extending between the cut portion and the end of the mat that does not contain the electrical power supply connections.

In a preferred embodiment, the mat 10 includes an electrical adapter outlet (not shown) that allows connecting a plurality of the mats 10 to each other in sequence. The adapter outlet also can include conventional electrical circuitry that provides for parallel electrical connection between adjacent mats in the sequence.

Although preferred embodiments of the present invention have been described and illustrated, it will be apparent to those skilled in the art that various modifications may be made without departing from the principles of the invention.

What is claimed is:

1. A flexible electric heating mat comprising:
an electric heater element containing a plurality of resistive elements coupled to at least two electrical conductors,
wherein the heater element includes a non-conductive sheet having a top surface and a bottom surface,
wherein the electrical conductors extend along a first dimension of the non-conductive sheet and between the top and bottom surfaces of the non-conductive sheet, and
wherein the resistive elements extend along a second dimension of the non-conductive sheet, between the top and bottom surfaces of the non-conductive sheet and are electrically coupled to the electrical conductors; and
a grounding substrate sheet having top and bottom surfaces, wherein the bottom surface of the grounding substrate sheet is coupled to the top surface of the non-conductive sheet, wherein the grounding substrate sheet includes a perimeter edge and all portions of the perimeter edge of the grounding substrate sheet are at least a predetermined distance away from any portion of the electrical conductors not covered by material of the non-conductive sheet,
wherein the predetermined distance is a minimum separation distance between the grounding substrate sheet and any portion of the electrical conductors not covered by material of the non-conductive sheet required to prevent arcing of electrical energy between the grounding substrate sheet and any portion of the conductors not covered by material of the non-conductive sheet when the electrical conductors of the mat are energized by electrical current provided by an electrical power source.

2. The mat of claim 1, wherein the predetermined distance is a function of the amount of electrical current to be provided by the power source and the material composition and structural dimensions of each of the electrical conductors, the non-conductive sheet and the grounding substrate sheet.

3. The mat of claim 1 further including:
top and bottom protective covering sheets adhesively bonded to the top surface of the grounding substrate sheet and the bottom surface of the non-conductive sheet, respectively, and to each other at perimeter edges of the covering sheets; and
head end and tail end terminations adhesively bonded to respective head and tail edges of the top and bottom protective covering sheets, wherein adhesive bonds formed with the protective covering sheets and the end terminations establish a hermetic seal about the heater element and the grounding substrate sheet.

4. The mat of claim 1, wherein the conductors extend adjacent to opposing lateral edges of the non-conductive sheet.

5. The mat of claim 1, wherein the resistive elements are substantially parallel to one another.

6. The mat of claim 1, wherein the grounding substrate sheet is at least the predetermined distance away from any portion of any of the resistive elements of the heater element not covered by the material of the non-conductive sheet.

7. The mat of claim 1, wherein the non-conductive sheet includes plastic.

8. A flexible electric heating mat comprising:
an electric heater element containing a plurality of substantially parallel resistive traces coupled at opposing ends to first and second electrical conductors, respectively,
wherein the heater element includes a non-conductive sheet having a top surface and a bottom surface,
wherein the first and second electrical conductors extend along a longitudinal length of the non-conductive sheet and adjacent to respective lateral edges of the non-conductive sheet, and
wherein the first and second electrical conductors and the resistive elements are between the top and bottom surfaces of the non-conductive sheet; and
a grounding substrate sheet having top and bottom surfaces, where the bottom surface of the grounding substrate sheet is coupled to the top surface of the non-conductive sheet, wherein the grounding substrate sheet includes a perimeter edge and all portions of the perimeter edge of the grounding substrate sheet are at least a predetermined distance away from any portion of the first and second electrical conductors not covered by material of the non-conductive sheet,
wherein the predetermined distance is a minimum separation distance between the grounding substrate sheet and any portion of the first and second electrical conductors not covered by material of the non-conductive sheet required to prevent arcing of electrical energy between the grounding substrate sheet and any portion of the first and second conductors not covered by material of the non-conductive sheet when the electrical conductors of the mat are energized by electrical current provided by an electrical power source.

9. The mat of claim 8, wherein the predetermined distance is a function of the amount of electrical current to be provided by the power source and the material composition and structural dimensions of each of the electrical conductors, the non-conductive sheet and the grounding substrate sheet.

10. The mat of claim 8 further including:
top and bottom protective covering sheets adhesively bonded to the top surface of the grounding substrate sheet and the bottom surface of the non-conductive sheet, respectively, and to each other at perimeter edges of the covering sheets; and
head end and tail end terminations adhesively bonded to respective head and tail edges of the top and bottom protective covering sheets, wherein adhesive bonds formed with the protective covering sheets and the end terminations establish a hermetic seal about the heater element and the grounding substrate sheet.

11. The mat of claim 8, wherein the conductors extend adjacent to opposing lateral edges of the non-conductive sheet.

12. The mat of claim 8, wherein the resistive elements are substantially parallel to one another.

13. The mat of claim 8, wherein the grounding substrate sheet is at least the predetermined distance away from any portion of any of the resistive elements of the heater element not covered by the material of the non-conductive sheet.

14. The mat of claim 8, wherein the non-conductive sheet includes plastic.

15. A flexible electric heating mat comprising:
a plurality of resistive elements coupled to at least first and second electrical conductors, wherein the first and second electrical conductors extend along a first dimension of the mat, and wherein the resistive elements extend along a second dimension of the mat and are electrically coupled to the first and second electrical conductors, wherein at least a portion of each of the first and second electrical conductors and the resistive element is covered with non-conductive material;
a third electrical conductor coupled to at least one of the first and second conductors, wherein at least a portion of the third electrical conductor is covered with non-conductive material;
a grounding substrate sheet including a perimeter edge, wherein all portions of the perimeter edge of the grounding substrate sheet are at least a predetermined distance away from any portion of the first, second and third electrical conductors not covered by the non-conductive material,
wherein the predetermined distance is a minimum separation distance between the grounding substrate sheet and any portion of the first, second and third electrical conductors and the resistive elements not covered by the non-conductive material required to prevent arcing of electrical energy between the grounding substrate sheet and any portion of the first, second and third electrical conductors and resistive elements not covered by the non-conductive material when at least one of the first, second and third electrical conductors of the mat is energized by electrical current provided by an electrical power source.

16. The mat of claim 15, wherein the predetermined distance is a function of the amount of electrical current to be provided by the power source and the material composition and structural dimensions of each of the electrical conductors, the resistive elements, the non-conductive sheet and the grounding substrate sheet.

17. The mat of claim 15 further including:
top and bottom protective covering sheets between which are disposed each of the conductors, the resistive elements and grounding substrate sheet, wherein the top and bottom sheets are adhesively bonded to each other at perimeter edges of the covering sheets; and
head end and tail end terminations adhesively bonded to respective head and tail edges of the top and bottom protective covering sheets, wherein adhesive bonds formed with the protective covering sheets and the end terminations establish a hermetic seal about the first, second and third electrical conductors, the resistive elements and the grounding substrate sheet.

18. The mat of claim 15, wherein the first and second conductors extend adjacent to opposing lateral edges of the non-conductive sheet.

19. The mat of claim 15, wherein the resistive elements are substantially parallel to one another.
